(19) United States
(12) Patent Application Publication
(10) Pub. No.: US 2018/0305246 A1
(43) Pub. Date: Oct. 25, 2018

(54) APPARATUS AND METHODS FOR A STRENGTHENED OVERFLOW INLINE COATED GLASS SHEET

(71) Applicant: KORNERSTONE MATERIALS TECHNOLOGY COMPANY, LTD., Fuzhou, Fujian (CN)

(72) Inventors: Frank Hung, Fuzhou, Fujian (CN); Jack Y. Ding, Fuzhou, Fujian (CN); Eric Chan, Fuzhou, Fujian (CN)

(21) Appl. No.: 15/770,832

(22) PCT Filed: Dec. 1, 2015
(86) PCT No.: PCT/CN2015/096169

§ 371 Date: Apr. 25, 2018

(51) Int. Cl. C03C 17/245; C03B 17/06; C03B 25/12; C03B 21/02; C03C 17/22

(52) U.S. Cl. CPC C03C 17/245; C03B 17/064; C03B 25/12; C03B 21/02; C03C 2218/151; C03C 2217/214; C03C 2217/70; C03C 2217/28; C03C 2218/1525; C03C 17/22

(57) ABSTRACT

Provided are an apparatus and a method for making a strengthened glass sheet including a glass layer with a first coefficient of thermal expansion and a first non-glass surface film formed on the glass layer, wherein the first non-glass surface film has a second coefficient of thermal expansion that is less than the first coefficient of thermal expansion and a compressive stress of at least 700 MPa.

### FIELD OF THE INVENTION

The present invention relates to a strengthened glass sheet having two surface films or coatings with a coefficient of thermal expansion that is different from the coefficient of thermal expansion of the inner glass layer, as well as an apparatus and methods for manufacturing the same.

### BACKGROUND

It is known that the mechanical strength of glass can be significantly increased by using an ion exchange process. In such ion exchange processes, the glass is placed in a molten salt containing ions having a larger ionic radius than the ions present in the glass, such that the smaller ions present in the glass are replaced by larger ions from the heated solution. Typically, potassium ions in the molten salt replace smaller sodium ions present in the glass. The replacement of the smaller sodium ions present in the glass by larger potassium ions from the heated solution results in compressive stress on the surface of the glass sheet, which strengthens the surface of the glass sheet.

Such processes can significantly increase production costs and time, require substantial additional production floor space, and present waste disposal issues. Thus, a glass with high strength where an ion exchange process is not required in the production or processing of the glass is desired.

### SUMMARY

A strengthened glass sheet having a surface film with a coefficient of thermal expansion that is different from the coefficient of thermal expansion of the inner glass layer to produce surface compressive stress is presented herein.

According to several exemplary embodiments, a method for making a strengthened glass sheet includes forming a glass layer with a first coefficient of thermal expansion (CTE) and a first non-glass surface film formed on the glass layer, wherein the first non-glass surface film has a second CTE that is less than the first CTE and a compressive stress of at least 700 MPa.

In some embodiments, the method includes forming a continuous glass ribbon using a glass overflow method, inline coating both surfaces of the continuous glass ribbon with a non-glass material to form a coated glass ribbon, and thereafter, cutting the coated glass ribbon into coated glass sheets.

In some embodiments, the system includes an inline coating apparatus that receives a continuous glass ribbon from a glass manufacturing apparatus and coats two surfaces of the continuous glass ribbon with a non-glass material while the continuous glass ribbon is in motion, thereby forming a coated glass ribbon.

### BRIEF DESCRIPTION OF THE DRAWINGS

FIG. 1 illustrates a schematic view of an apparatus for manufacturing a strengthened glass sheet according to certain embodiments.

FIG. 2 illustrates a perspective view of an apparatus for manufacturing a strengthened glass sheet according to certain embodiments.

FIG. 3 illustrates a perspective view of an apparatus for manufacturing a strengthened glass sheet according to certain embodiments.

FIG. 4 illustrates a flow diagram illustrating a method for manufacturing a strengthened glass sheet, according to certain embodiments.

FIG. 5 illustrates a cross section of a strengthened glass sheet according to certain embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Strengthened glass sheets as disclosed having a compressive stress on the surface include glass sheets having a surface coating of a non-glass material. Such glass sheets can be fabricated using an overflow inline coating process by a system having inline coating. Thus, strengthened glass, the system and the method of making the same are described below.

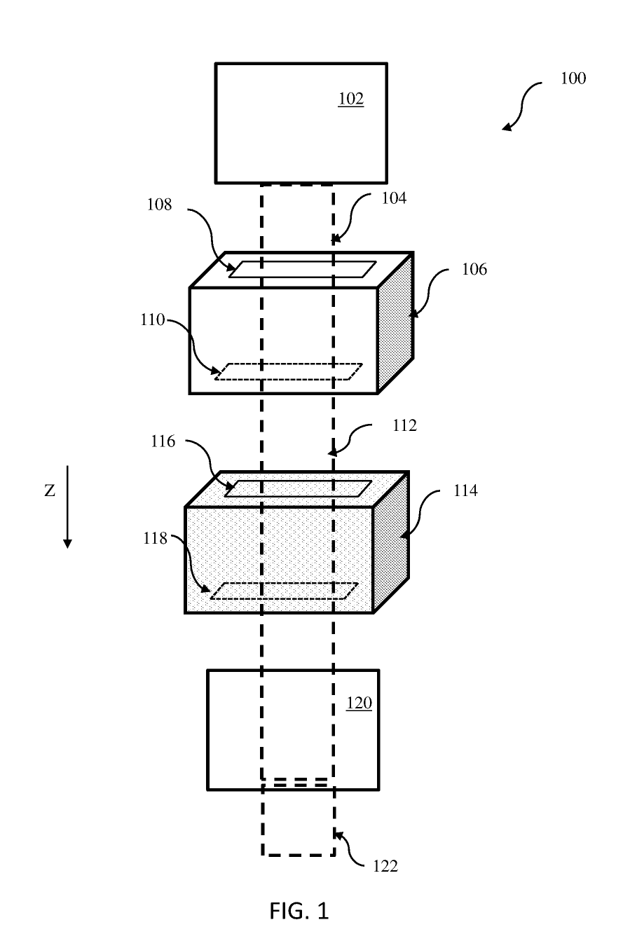

FIG. 1 illustrates a schematic view of an overflow inline coating system 100 that can be used to make the strengthened glass sheets described herein. The system 100 includes a glass manufacturing apparatus 102 for making a continuous flat glass ribbon 104. In the present embodiment, the glass manufacturing apparatus 102 is designed for forming flat glass by overflow down draw technology.

The system 100 includes an inline coating apparatus 106 for coating the continuous flat glass ribbon 104. As shown, the inline coating apparatus 106 is disposed below the glass manufacturing apparatus 102. The inline coating apparatus 106 is operable to receive and coat the continuous flat glass ribbon 104. The corresponding inline coating process from the inline coating apparatus 106 is referred to as inline coating since such coating is applied to the flat glass ribbon 104 while the flat glass ribbon 104 continuously flows from the glass manufacturing apparatus 102. Particularly, the inline coating process occurs while the flat glass ribbon 104 is in motion and continuously flows through the inline coating apparatus 106. Specifically, the flat glass ribbon 104 continuously flows vertically in the Z direction shown in FIG. 1 through the inline coating apparatus 106 during the inline coating process. Accordingly, the inline coating apparatus 106 has a first opening 108 and a second opening 110 designed to be vertically aligned. The first opening 108 and the second opening 110 are shaped and sized such that the continuous flat glass ribbon 104 is able to flow into the first opening 108 and flow out of the second opening 110.

In various embodiments, the inline coating apparatus 106 has a coating mechanism, such as atmospheric pressure plasma deposition (AP plasma or APPD), physical vapor deposition (PVD), or chemical vapor deposition (CVD). During the inline coating process, the flat glass ribbon 104 is fed into the inline coating apparatus 106, where it is coated on both surfaces (prior to any cutting or secondary operations) in the deposition chamber, which is an open space defined between the first opening 108 and the second opening 110. As the inline coating apparatus 106 has a coating site open to the environment, the apparatus is maintained at an atmospheric pressure and may be further plasma enhanced for coating efficiency during the inline coating process. Thus, the deposition mechanism may be one of atmospheric pressure plasma deposition (APPD), atmospheric pressure PVD (APPVD) and atmospheric pressure CVD (APCVD). In other embodiments, the pressure can be dynamically maintained at a pressure slightly lower or higher than the atmospheric pressure by a proper method, such as pumping, supplying an inert gas (such as argon) of lower density (lower pressure) or higher density (higher pressure), or a combination thereof.

In some embodiments, the inline coating apparatus 106 coats surfaces of the flat glass ribbon 104 with a non-glass material that has a coefficient of thermal expansion (CTE) that is less than that of the flat glass ribbon 104. In some examples, the non-glass material includes one of alumina (Al₂O₃), aluminum oxynitride (AlON), and diamond. In the present embodiment, the inline coating apparatus 106 is designed to coat both surfaces of the flat glass ribbon 104 symmetrically such that the flat glass ribbon is sandwiched between the non-glass films. In furtherance of the embodiment, both coated non-glass surface films are symmetric in terms of composition, thickness and stress.

The inline coating apparatus 106 and the inline coating process are further designed such that various parameters are properly adjusted to form the coated flat glass 112 with enhanced mechanical strength. These parameters may include the composition of the non-glass material, the coating temperature, and film thickness.

The flat glass ribbon 104 is formed by the glass manufacturing apparatus 102 at a first forming temperature T1, greater than 1000° C. for example. This formed flat glass ribbon 104 moves down to the inline coating apparatus 106 and cools down to a second temperature T2 that is less than the first temperature T1. By properly configuring the vertical distance between the glass manufacturing apparatus 102 and the inline coating apparatus 106, the second temperature T2 can be tuned to a desired coating temperature. Alternatively, the inline coating apparatus 106 further includes a heating module to heat the flat glass ribbon 104 to reach the desired coating temperature. The heating module may also function to compensate for the temperature fluctuation during the inline coating process, or among various inline coating processes, for consistent and expected coating temperatures. When the flat glass ribbon 104 flows out of the inline coating apparatus 106, it becomes coated flat glass ribbon 112.

In some embodiments, the overflow inline coating system 100 may further include a post-treatment apparatus 114 disposed below the inline coating apparatus 106. The post-treatment apparatus 114 is operable to further treat the coated non-glass material for enhanced quality, such as improved crystal quality and enhanced mechanical hardness. In some embodiments, the post-treatment apparatus 114 includes an annealing mechanism to anneal the coated surfaces. For post-treatment with an annealing mechanism, the coated surface may be treated at a temperature that is greater than a high temperature, such as 1000° C. or higher. However, the glass softening temperature is at a lower temperature, such as a temperature between 600° C. and 800° C. The heating mechanism is chosen and the post-treatment apparatus 114 is designed so that heating effects on the inner glass layer are minimized, while still heat treating the coated non-glass film. Considering that the glass ribbon is continuously produced and coated, atmospheric pressure-type flash assist rapid thermal annealing processes (also known as flash lamp annealing) and pulsed laser annealing may be used to obtain a high crystalline quality of the film quickly without damaging the inner glass. Similarly, the post-treatment is applied to the coated flat glass ribbon 112 while it is in motion. Particularly, the post-treatment apparatus 114 also includes a first opening 116 to receive the coated glass ribbon 112 and a second opening 118 to release the coated glass ribbon 112. While the coated glass ribbon 112 moves through the post-treatment apparatus 114, a post-treatment process is simultaneously applied to the coated glass ribbon 112.

The overflow inline coating system 100 also includes a cutting apparatus 120 disposed below the inline coating apparatus 106. In some embodiments, the post-treatment apparatus 114 is present and the cutting apparatus 120 is disposed below the post treatment apparatus 114. The cutting apparatus 120 is designed to cut the coated flat glass ribbon 112 into coated flat glass sheets 122. The cutting apparatus 120 may use any suitable cutting mechanism to cut the coated glass ribbon 112. By the disclosed system 100, the glass ribbon is formed, is coated, and thereafter is cut into flat glass sheets. The overflow inline coating system 100 includes a module to form a flat glass ribbon by an overflow method and an inline coating module to coat the flat glass ribbon using non-glass material. Various embodiments of the overflow inline coating system 100 are further described below.

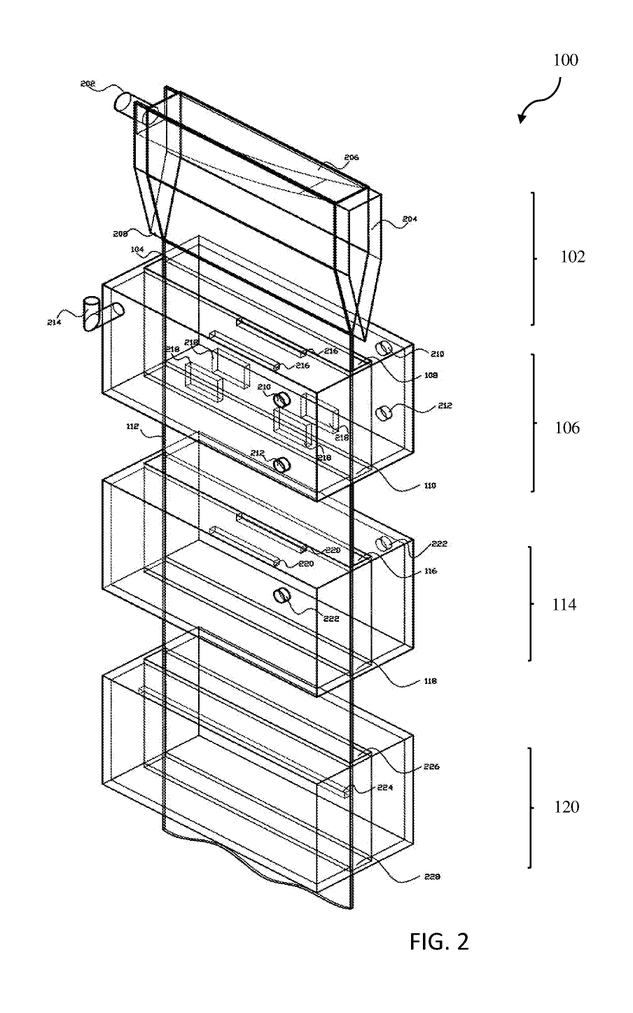

FIG. 2 shows a perspective view of an overflow inline coating system 100 that can be used to make the strengthened glass sheets described herein. The system 100 includes an overflow glass manufacturing apparatus 102 for making a continuous flat glass ribbon 104, an inline coating apparatus 106 for coating the flat glass ribbon 104 with a non-glass material, an annealing apparatus 114, and a cutting apparatus 120.

The overflow glass manufacturing apparatus 102 includes conduit 202 and trough 204 configured to enable an overflow mechanism to form flat glass ribbon 104. The conduit 202 is integrated with the trough 204 to provide hot glass to the trough 204. Hot glass is introduced to the trough 204 through the conduit 202, overflows from the trough top 206 from trough top 206 and two sides of the trough 204, and then merges together at the trough bottom 208. Thereby, the continuous flat glass ribbon 104 is formed.

The inline coating apparatus 106 is disposed below the overflow glass manufacturing apparatus 102. The inline coating apparatus 106 is designed and configured to implement AP plasma, PVD or CVD coating process. Furthermore, the inline coating apparatus 106 is designed to coat both surfaces of the flat glass ribbon 104 symmetrically. The inline coating apparatus 106 includes one or more ports to provide one or more chemicals for inline coating. In the present embodiment, the inline coating apparatus 106 includes a first gas port 210 and a second gas port 212, which are configured to provide different gases (such as reactive gases in various combinations according to the non-glass material) into the coating apparatus 106 for different processes and reactions. The inline coating apparatus 106 also includes a suction channel 214 that takes away the byproducts produced in the process, heating device 216 that keeps the glass sheet at a constant temperature and/or for use in physical vapor deposition or chemical vapor deposition, and plasma generating device 218 that ionizes gas introduced by gas ports (such as 210 and 212) to generate plasma for plasma coating processes. Particularly, the inline coating apparatus 106 includes the first opening 108 and a second opening 110 designed for the flat glass ribbon to move through. The first opening 108 and the second opening 110 are designed with a proper shape and size compatible with the flat glass ribbon 104. In the present embodiment, the first and second openings (108 and 110) are configured to be vertically aligned.

The annealing apparatus 114 is designed to heat the coated flat glass ribbon 112 for post treatment. The annealing apparatus 114 includes heating devices 220 and gas discharge ports 222. The heating mechanism allows the coated non-glass material to be heated to a higher temperature (such as greater than 1000° C.) while maintaining the inner glass ribbon at a lower temperature (such as below the glass melting temperature). In some embodiments, the heating devices 220 include flash lamps, pulsed laser devices, or a combination thereof for heating. In furtherance of the embodiments, the heating devices 220 are designed to symmetrically heat both surfaces of the coated flat glass ribbon 112. For example, two or more heating devices 220 are configured on both sides for symmetric heating effect. On each side, the heating devices 220 may be configured in a line (or a linear array) perpendicular to the flow direction (the Z direction in FIG. 1) of the glass ribbon so that, for example, a laser array is able to scan the coated glass ribbon when it moves through the post-treatment apparatus 114. Alternatively, the heating devices 220 on each side are configured in a two-dimensional array in a plane that is parallel with the glass ribbon 112. In some examples, for flash lamp annealing, the flash frequency ranges from one microsecond (μs) to one second (s) to treat the coated film. In some embodiments for pulse laser annealing, the laser source can be, for example, an excimer laser, an Nd:YAG laser, a carbon dioxide laser, or a diode laser. The power of the laser source, in various embodiments, ranges from 500 mW to 100 W. The laser pulse frequency may range from one microsecond (μs) to one second (s). In other examples, the heating devices 220 may be further controlled through a feedback control mode or other control mode for real time compensation of the heating variation among two surfaces and from location to location. Gas discharge ports 222 can be used to inject different reaction gases for different film materials, or can be used to inject an inert gas to maintain cleanliness of film material after annealing. Heating devices 220 receive the coated flat glass ribbon 112 for heating to obtain a thin film having a high crystal quality. Furthermore, the annealing apparatus 114 also includes a first opening 116 and a second opening 118 designed for the flat glass ribbon 112 to move through. Similarly, the first opening and second openings are designed with proper shape and size compatible with the flat glass ribbon 112. In the present embodiment, the first and second openings (116 and 118) are configured to be vertically aligned.

The overflow inline coating system 100 also includes a cutting apparatus 120 disposed below the annealing apparatus 114. The cutting apparatus 120 is designed to cut the coated flat glass ribbon 112 into coated flat glass sheets 122. The cutting apparatus 120 may use any suitable cutting mechanism 224 to cut the coated glass ribbon 112. The cutting operations are implemented while the glass ribbon 112 is in motion. The cutting apparatus 120 is designed with various components, such as robot arms with vacuum pads for securing the glass ribbon, and for securing and transferring the separated glass sheet. The cutting apparatus 120 is also designed at the first location 226 to receive the coated glass ribbon 112 and at the second location 228 to transfer the glass sheet 122. In the disclosed system 100, the flat glass ribbon is formed, and coated (and optionally post treated). Only thereafter is it cut into flat glass sheets 122.

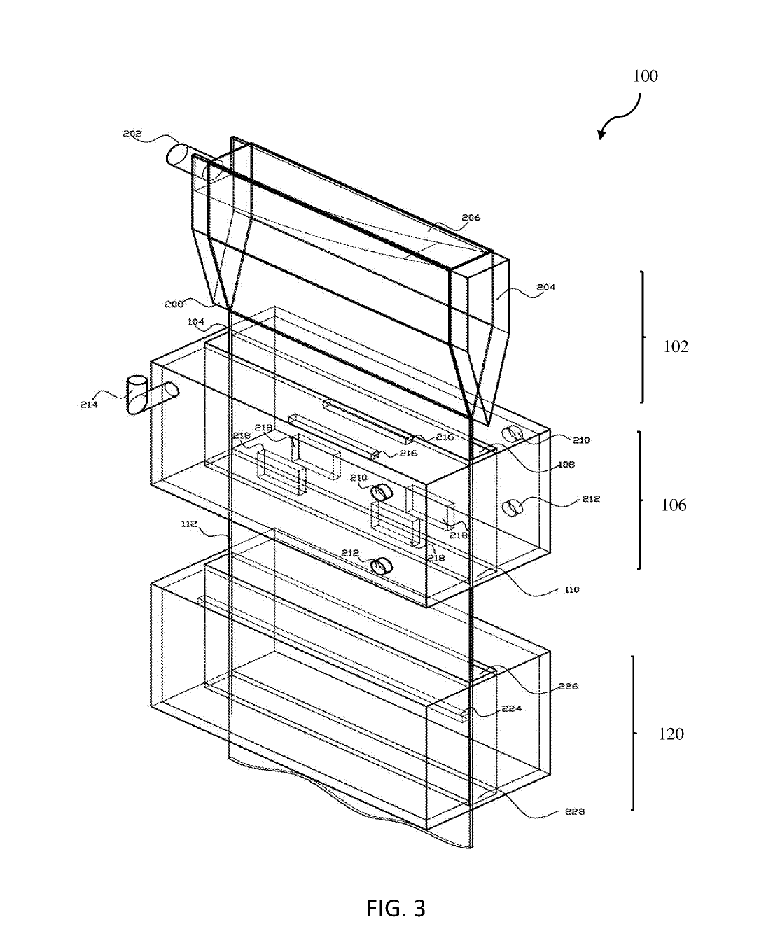

FIG. 3 shows a perspective view of an overflow inline coating system 100, constructed according to other embodiments. The overflow inline coating system 100 in FIG. 3 is substantially similar to the overflow inline coating system 100 in FIG. 2. However, the post-treatment apparatus 114 is eliminated. Thus, the cutting apparatus 120 is directly disposed below the inline coating apparatus 106.

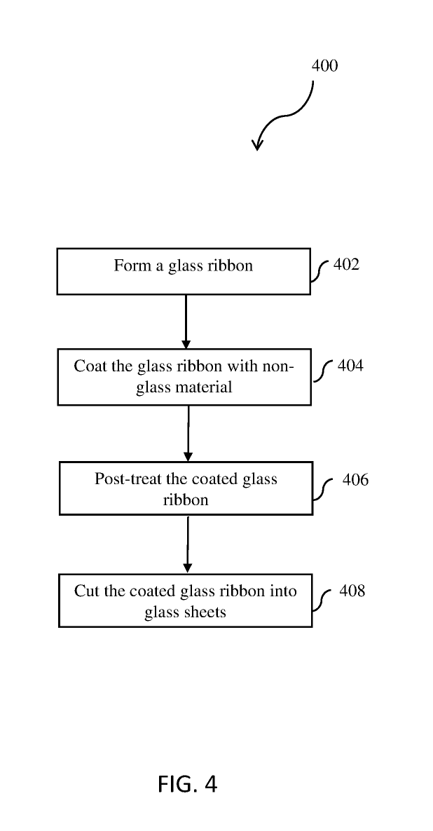

FIG. 4 provides a flow diagram for a method 400 for fabricating a strengthened glass sheet by the overflow inline coating system 100. The method 400 is described with reference to FIGS. 1 through 4. The method 400 begins at operation 402 by forming a continuous flat glass ribbon 104. Molten glass is introduced into the glass manufacturing apparatus 102. Particularly, the molten glass flows through conduit 202 to trough 204, overflows trough 204 to flow down over trough top 206 in two portions that meet together at trough bottom 208 to form a continuous flat glass ribbon 104.

The method 400 includes an operation 404 by coating the flat glass ribbon 104 using a non-glass material, thereby forming a coated glass ribbon 112. In the present embodiment, the operation 404 generates the coated non-glass film in a crystal structure. Particularly, the operation 404 is also referred to as an inline coating process since the continuous flat glass ribbon 104 is in motion during the corresponding coating process. The flat glass ribbon 104 continuously moves from the glass manufacturing apparatus 102 to the inline coating apparatus 106 and through the inline coating apparatus 106 for inline coating. The flat glass ribbon 104 is fed into inline coating apparatus 106, where the flat glass ribbon 104 is coated on both surfaces by a coating mechanism selected from PVD and CVD, prior to any cutting or secondary operations. The non-glass material in the coated surface films has suitable characteristics, such as a lower CTE than that of the inner glass ribbon, such that the final glass sheet is strengthened. In some examples, the non-glass material includes one of alumina (Al₂O₃), aluminum oxynitride (AlON), and diamond. As the inline coating apparatus 106 has a coating site open to the environment, the apparatus is maintained at atmospheric pressure and may be further plasma enhanced for coating efficiency during the inline coating process. The heating device 216 may be further used to control, adjust, and tune the coating temperature for optimized coating effect and quality.

In the present embodiments, the inline coating apparatus 106 is designed such that the flat glass ribbon 104 is coated on both surfaces by the non-glass material. In furtherance of the embodiments, the two surfaces of the flat glass ribbon 104 are coated symmetrically in terms of composition and thickness. In alternative embodiments, the inline coating apparatus 106 is designed such that the flat glass ribbon 104 is coated on one surface by the non-glass material. The inline coating apparatus 106 and the inline coating process are further designed such that various parameters are properly adjusted to form the coated flat glass 112 with enhanced mechanical strength. These parameters may include the composition of the non-glass material, the coating temperature, and film thickness.

Advantageously, the glass ribbon 104 remains at a high temperature (e.g., about 900-1000° C.) as it flows away from the glass manufacturing apparatus 102 and to the inline coating apparatus 106, so the flat glass ribbon 104 does not need to be separately heated or only needs minimal heating. Because the temperature of the flat glass ribbon 104 drops as it moves away from the glass manufacturing apparatus 102, a location on the glass ribbon 104 with a temperature that is suitable for coating (e.g., about 500-600° C.) can be properly chosen. When choosing the proper temperature two factors may be considered, such as deposition condition and the final stress built in the coated film after the coated glass is cooled down to room temperature. In other words, the vertical distance between the glass manufacturing apparatus 102 and the inline coating apparatus 106 is chosen properly. In some embodiments, however, the glass ribbon 104 is heated to the appropriate temperature for coating (using heating device 216 for example). Because the glass ribbon 104 is continuous (e.g., it is continually produced at apparatus 102 and continually moves to apparatus 106) and is in motion, the coating time is determined by the speed of the glass ribbon 104 and the vertical dimension of the coating chamber defined in the inline coating apparatus 106. To achieve an expected thickness of the coating film, the coating rate by the inline coating apparatus 106 is controlled and is adjusted. The rate at which the glass ribbon 104 is produced or the rate at which the glass ribbon 104 flows downward can also be controlled to ensure adequate coating time for the expected coating thickness.

The PVD and CVD processes can take place at different operating pressures, for example, at atmospheric pressure (about 760 torr), low vacuum pressure (about 100 torr), and high vacuum pressure (about 10⁻³ torr). Use of high vacuum pressure PVD typically can produce high-quality films, and the processing or operating temperature is generally between 200-600° C. CVD, on the other hand, requires higher processing temperatures of about 1000° C.

Plasma assisted CVD/plasma enhanced CVD (PECVD) may be used to reduce the operating temperature. PECVD can deposit a film usually in a vacuum of about 10⁻²-10⁻³ torr. PECVD can be used for low temperature deposition of films to produce films with high bonding strength. Film thicknesses and chemical compositions of the film can be controlled using PECVD. Atmospheric pressure plasma deposition, APPVD, and APCVD may be used to produce the films or coatings described herein. Coating at atmospheric pressure may have a coating rate greater than the rates obtained in high vacuum pressure PVD and PECVD. By further tuning other coating conditions and parameters, such as coating temperature, coated non-glass films with expected compressive stress can be achieved.

Other deposition parameters may be designed and adjusted according to the above considerations and other factors relevant to the coated glass quality, such as stress, hardness and deposition technology. The inline coating apparatus 106 may include an AP plasma deposition mechanism with the corresponding deposition chamber defined between the first opening 108 and the second opening 110. In some embodiments, the AP plasma deposition has a deposition temperature ranging between 400° C. and 1200° C. In some embodiments, the AP plasma deposition has a deposition pressure ranging between 500 Torr and 800 Torr. The AP plasma deposition also includes supplying various chemicals, such as carrying gas and reactive gas. In some embodiments, the AP plasma deposition includes supplying argon (Ar), oxygen (O₂) and nitrogen (N₂). In some embodiments, the AP plasma deposition includes a plasma power ranging between 10 W/cm² and 1000 W/cm². In other embodiments, thus coated non-glass material film includes aluminum alloy, alumina, aluminum oxynitride, aluminum nitride, and diamond.

The inline coating apparatus 106 may include a PVD mechanism with the corresponding deposition chamber defined between the first opening 108 and the second opening 110. The PVD includes three basic steps: (1) vaporization of a solid target material, (2) transportation of the vapor to the substrate surface, and (3) condensation onto the substrate to generate thin films. The target material may be heated until evaporation (thermal evaporation) or sputtered by ions (sputtering). In the latter case, ions can be generated by a plasma discharge usually within an inert gas (e.g., Ar). It is also possible to bombard the target material with an ion beam from an external ion source.

In some embodiments, the PVD has a deposition temperature greater than 300° C. In some embodiments, the PVD has a deposition pressure ranging between 500 Torr and 800 Torr. The PVD also includes supplying various chemicals, such as carrying gas and reactive gas. In some embodiments, the PVD includes supplying argon (Ar), oxygen (O₂) and nitrogen (N₂). In some embodiments, the PVD includes a plasma power ranging between 10 W/cm² and 1000 W/cm². In other embodiments, the PVD includes using a target having a material selected from aluminum, alumina, aluminum oxynitride, aluminum nitride, and diamond. According to several exemplary embodiments, the purity of the aluminum target ranges between 95% and 99.9999%. According to several exemplary embodiments, the purity of the carbon target ranges between 95% and 99.9999%. In some examples, the PVD uses alumina targets with an aluminum/oxygen ratio (Al/O) ranging between 0.6 and 0.7. In some examples, the PVD uses aluminum oxynitride targets that have a first ratio Al/(O+N) ranging between 0.45 and 0.55 and a second ratio O/(O+N) ranging between 0.01 and 0.99. In some examples, the PVD uses aluminum nitride targets with an aluminum/nitrogen ratio (Al/N) ranging between 0.45 and 0.55. In the above descriptions, a ratio is defined by atomic numbers.

The inline coating apparatus 106 may include a CVD mechanism with the corresponding deposition chamber defined between the first opening 108 and the second opening 110. In some embodiments, the CVD has a deposition temperature greater than 700° C. In some embodiments, the CVD has a deposition pressure ranging between 500 Torr and 800 Torr. In some examples, PECVD is used to coat the flat glass ribbon 104. The CVD also includes supplying various chemicals, such as carrying gas and reactive gas. In some embodiments, the PVD includes supplying Ar, O₂, N₂, H₂, and CH₄.

Still referring to FIG. 4, the method 400 optionally includes an operation 406 of performing a post-treatment process on the coated glass ribbon 112 using the post-treatment apparatus 114. In the present embodiment, the post-treatment is an annealing process performed on the coated glass ribbon 112. As noted above, the coated non-glass film is in a crystal structure. To improve the crystalline quality of the film, the coated glass ribbon 112 may be subjected to post-treatment at temperatures of greater than 1000° C. However, the glass softening temperature is about 600-800° C. In order to treat the coated non-glass material at a higher temperature while the heating effect on the inner glass is minimized (the inner glass is maintained at a lower temperature, such as below the softening temperature), an annealing mechanism is designed to provide rapid annealing and achieve the significant temperature difference between the inner glass and the coated non-glass material. In some embodiments, the post-treatment apparatus 114 provides flash lamp annealing, pulse laser annealing or other suitable rapid thermal annealing processes at atmospheric pressure. Similarly, the post-treatment is applied to the coated flat glass ribbon 112 while it is in motion. While the coated glass ribbon 112 moves through the post-treatment apparatus 114, a post-treatment process is simultaneously performed on the coated glass ribbon 112. In some embodiments, the post treatment in the operation 406 may further include supplying suitable gas (reactive gas, protective gas or both), such as Ar, O₂, N₂, H₂ or a combination thereof, to the post-treatment apparatus 114 through the gas port 222. According to several exemplary embodiments, a rapid thermal annealing process is used to post-treat the films. In one embodiment, the rapid thermal annealing takes place at atmospheric pressure (e.g., 500-800 Torr). In some embodiments, the annealing process can subject the coated non-glass films (such as Al₂O₃, AlON, or diamond film) to temperatures between 100° C. and 1200° C.

In some embodiments, the post-treatment 406 includes annealing the coated glass ribbon 112 by rapid thermal annealing using halogen lamps. In some examples, the lamp annealing takes place at atmospheric pressure (e.g., 500-800 Torr). In several examples, the coated glass ribbon 112 is heated at a rate of about 40° C. to 150° C./second to treat an Al₂O₃, AlON, or diamond film. In some examples, the lamp as the heating source flashes with a flash frequency ranging from one microsecond (μs) to one second (s) to treat the coated film. In other examples, the coated non-glass films are heated to temperatures between 100° C. and 1200° C. by flash lamp annealing.

In some embodiments, the post-treatment 406 includes annealing the coated glass ribbon 112 by pulse laser annealing. In one embodiment, the pulse laser annealing takes place at atmospheric pressure (e.g., 500-800 Torr). The pulse laser annealing process can subject the coated glass sheet to temperatures of about 100° C. to 1500° C. The laser source can be, for example, an excimer laser, an Nd:YAG laser, a carbon dioxide laser, or a diode laser. The power of the laser source, in various embodiments, ranges from 500 mW to 100 W. In certain embodiments, the laser source provides a single-point circular laser spot with a diameter ranging between 1 mm to 20 mm to treat an Al₂O₃, AlON, or diamond film. According to several exemplary embodiments, in a laser annealing process, the laser devices are configured in a line (or a linear array) perpendicular to the flow direction of the glass ribbon so that the laser array is able to scan the coated glass ribbon 112 when it moves through the post-treatment apparatus 114. According to several exemplary embodiments, the laser devices are configured in a two-dimensional array. The laser pulse frequency may range from one microsecond (μs) to one second (s).

The method 400 includes an operation 408 of cutting the coated glass ribbon 112 into a plurality of flat glass sheets 122, such as by using the cutting apparatus 120 disposed below the inline coating apparatus 106 (or disposed further below the post-treatment apparatus 114 when the post-treatment is present). In the operation 408, the coated glass ribbon 112 is cut into the appropriate size for a particular application or generic application. In alternative embodiments, the cutting apparatus 120 is programmed to cut the coated glass ribbon 112 into glass sheets of different sizes for various applications. In various embodiments, the operation 408 includes cutting the coated glass ribbon 112, securing the separated glass sheet 122, and transferring the glass sheet 122. This formed glass sheet 122 has coated non-glass surface films with a compressive stress for strengthened mechanical stress when it is cooled down to room temperature. The coated non-glass surface films may also have crystal structure with enhanced hardness. This formed glass sheet 122 is further described below in detail.

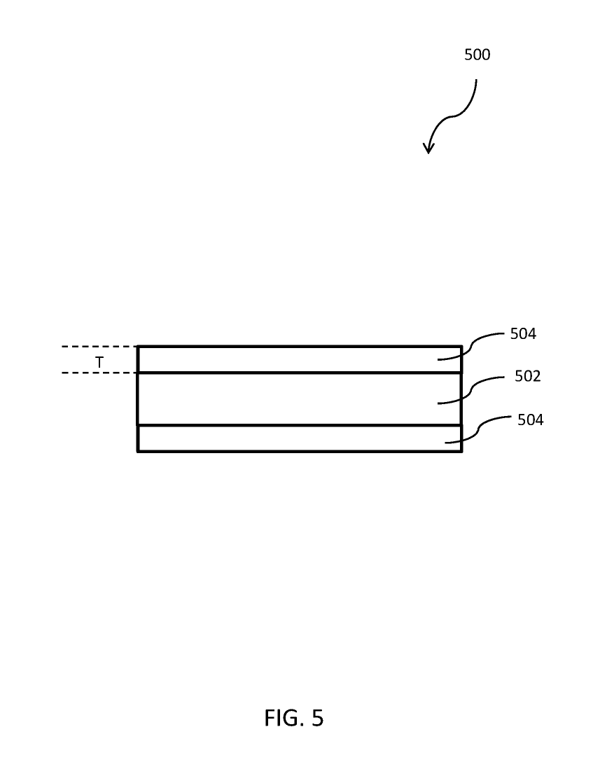

FIG. 5 shows a cross-sectional view of a glass sheet 500 formed by the method 400 and the overflow inline coating system 100, constructed according to aspects of the present disclosure in various embodiments. For example, the glass sheet 500 may be the glass sheet 122 in FIG. 1 or a portion of the glass sheet after further cutting and/or further fabrication operations.

The glass sheet 500 includes an inner glass layer 502 with coated surface film 504 of a non-glass material. The non-glass surface film has a different coefficient of thermal expansion (CTE) than that of the inner glass layer 502. Furthermore, the surface film 504 has a compressive stress of at least 700 MPa.

The inner glass layer 502 is formed by the operation 402, such as an overflow method in the present embodiment. Any suitable glass material may be used for the inner glass layer 502. For example, aluminosilicate glass or borosilicate glass may be used in the inner glass layer 502. The inner glass layer 502 may optionally contain additional compositions or dopants that modify the CTE, and/or various other parameters and characteristics of the inner glass layer. In some embodiments, the inner glass layer 502 has a thickness ranging from 0.2 mm to 1 mm.

The surface film 504 is formed by the inline coating operation 404 and may be further treated by the operation 406 for post-treatment. In some embodiments, the coated film 504 has a thickness “T” ranging from 0.3 μm to 10 μm. According to several exemplary embodiments, the surface film 504 is disposed on both surfaces of the inner glass layer 502, and not on the edges of the inner glass layer 502. The surface film 504 includes a non-glass material chosen and designed for strengthening effect. The non-glass material has a different coefficient of thermal expansion (CTE) than the inner glass layer 504. Particularly, the CTE “Cn” of the non-glass material is less than the CTE “Cg” of the inner glass layer 502.

After the non-glass material is inline coated onto the inner glass layer 502 at an elevated temperature, during cooling, the inner glass layer 502 contracts and/or shrinks more than the surface film 504. This results in the glass sheet 500 exhibiting an internal tension and an external pressure state on the surface. The compressive stress is built up in the surface film 504, thereby increasing the strength of the coated glass.

Selection of materials with high hardness for the coated film 504, such as alumina or diamond, can also provide high scratch resistance to the glass sheet 500. In some embodiments, the non-glass material in the coated film 504 includes one of alumina (Al₂O₃), aluminum oxynitride (AlON), and diamond. According to several exemplary embodiments, the surface film 504 has a crystal structure, such as crystalline phase Al₂O₃ or crystalline phase AlON, for increased hardness. In the present embodiment, the surface film 504 is in a crystal structure when being coated and the crystal quality (such as crystallinity) is further improved by the post-treatment. According to several exemplary embodiments, the surface coatings 504 include α-Al₂O₃. In furtherance of the embodiment, the surface coatings 504 are in α-phase with a hardness greater than 25 GPa. According to several exemplary embodiments, the atomic ratio of Al/O in the Al₂O₃ ranges from 0.6 to 0.7. According to several exemplary embodiments, the atomic ratio of Al/(O+N) in the AlON ranges from 0.45 to about 0.55 and the ratio of O/(O+N) ranges from 0.01 to 0.99.

The CTE when referenced herein is the average CTE of a given material or layer between 0° C. and 300° C. In some embodiments, in a temperature range from 0° C. and 300° C., the ratio Cg/Cn is greater than 1.1, for example, greater than 1.5, greater than 10, greater than 25, greater than 50, greater than 75, or greater than 90. According to several exemplary embodiments, the ratio of the CTE of the inner glass layer 502 to the surface film 504 results in a compressive stress of at least 700 MPa on the surface film 504, for example, at least 1000 MPa, at least 1500 MPa, at least 5000 MPa, or at least 10,000 MPa.

To examine the effects of CTE and thickness on compressive stress, a series of exemplary glass sheets were manufactured having varying ratios of CTEs and thicknesses. Table 1 indicates the mechanical properties of the alumina used, Table 2 indicates the mechanical properties of the diamond used, and Table 3 indicates the mechanical properties of the inner glass layer.

TABLE 1
Alumina Film Properties

| | |
|---|---|
| Density | 3.98 g/cm³ |
| Elastic Modulus | 335 GPa |
| Poisson Number | 0.25 |
| CTE | 56 × 10⁻⁷ |

TABLE 2
Diamond Film Properties

| | |
|---|---|
| Density | 3.52 g/cm³ |
| Elastic Modulus | 1,220 GPa |
| Poisson Number | 0.2 |
| CTE | 1.1 × 10⁻⁷ |

TABLE 3
Inner Glass Properties

| | |
|---|---|
| Density | 2.46 g/cm³ |
| Elastic Modulus | 69.8 GPa |
| Poisson Number | 0.194 |
| CTE | 104 × 10⁻⁷ |

The glass sheets were subjected to conditions that simulated coating at 825° C. and cooling to room temperature. Surface film lamination stress values were calculated using a finite element method. Two thicknesses (0.7 mm and 0.4 mm) of the inner glass layer were examined, and four film thicknesses (0.5, 1, 2, and 10 μm) were examined. The results with the alumina film are provided in Table 4, and the results with the diamond film are provided in Table 5.

TABLE 4
Alumina Film Compressive Stress Results

Inner Glass Thickness

| Alumina Film Thickness | 0.7 mm | 0.4 mm |
|---|---|---|
| 0.5 μm | 1,690 MPa | 1,672 MPa |
| 1 μm | 1,666 MPa | 1,631 MPa |
| 2 μm | 1,620 MPa | 1,555 MPa |
| 10 μm | 1,325 MPa | 1,132 MPa |

TABLE 4
Diamond Film Compressive Stress Results

Inner Glass Thickness

| Diamond Film Thickness | 0.7 mm | 0.5 mm |
|---|---|---|
| 0.5 μm | 11,952 MPa | 11,728 MPa |
| 1 μm | 11,406 MPa | 11,004 MPa |
| 2 μm | 10,451 MPa | 9,794 MPa |
| 10 μm | 6,257 MPa | 5,212 MPa |

As can be seen from the results, high compressive stresses are obtained across the different inner glass thicknesses and different alumina and diamond film thicknesses. According to several exemplary embodiments, the thickness of the inner glass layer can range from about 0.2 mm to about 1 mm. According to several exemplary embodiments, the thicknesses of the films or coatings can range from about 0.3 μm to about 10 μm.

A strengthened glass sheet, a system and a method of making the same are disclosed according to various embodiments. Various alternatives and additions may be made without change the scope of the present disclosure. For example, the surface film may be formed only on one surface for certain suitable applications. In another example, other post-treatments, such as ion implantation may be further applied to the surface film to enhance certain parameters of the glass sheet, such as surface stress and hardness. In yet another example, the inline coating method may alternatively be used to coat a glass film to the inner glass layer. This coated glass film has a different characteristic to that of the inner glass layer, such as with different CTEs that lead to a compressive stress on the coated glass film.

The present disclosure has been described relative to certain embodiments. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

What is claimed is:

1. A glass sheet comprising:
a glass layer having opposing first and second surfaces and having a first coefficient of thermal expansion (CTE); and
a first non-glass surface film formed on the first surface of the glass layer, wherein the first non-glass surface film has a second CTE that is less than the first CTE and a compressive stress of at least 700 MPa.

2. The glass sheet of claim 1, wherein a ratio of the first CTE to the second CTE is greater than 1.1 at a temperature of from 0° C. to 300° C.

3. The glass sheet of claim 1, further comprising a second non-glass surface film formed on the second surface of the glass layer, wherein the first and second non-glass surface films are identical in terms of composition, thickness and stress.

4. The glass sheet of claim 1, wherein the first non-glass surface film has a crystal structure.

5. The glass sheet of claim 1, wherein the non-glass surface film comprises one of alumina (Al₂O₃), aluminum oxynitride (AlON), and diamond.

6. The glass sheet of claim 5, wherein the Al₂O₃ in the non-glass surface film is in α-phase with a hardness greater than 25 GPa.

7. The glass sheet of claim 5, wherein the atomic ratio of Al/(O+N) in the AlON ranges from 0.45-0.55 and the ratio of O/(O+N) ranges from 0.01 to 0.99.

8. The glass sheet of claim 1, wherein
a thickness of the inner glass layer ranges from 0.2 mm to 1 mm; and
a thickness of the first non-glass surface films ranges from 0.3 μm to 10 μm.

9. A method of forming a glass sheet comprising:
forming a continuous glass ribbon using a glass overflow method;
inline coating at least one surface of the continuous glass ribbon with a non-glass material to form a coated glass ribbon; and
cutting the coated glass ribbon into coated glass sheets.

10. The method of claim 9, wherein the inline coating includes coating the continuous glass ribbon while the continuous glass ribbon is in motion.

11. The method of claim 10, wherein the inline coating includes coating the continuous glass ribbon in a deposition tool while the continuous glass ribbon moves down in the deposition tool and moves down out of the deposition tool.

12. The method of claim 11, wherein the inline coating includes coating using one of atmospheric pressure plasma deposition (APPD), atmospheric pressure physical vapor deposition (APPVD), and atmospheric pressure chemical vapor deposition (APCVD), wherein the non-glass material has a coefficient of thermal expansion (CTE) that is less than that of the continuous glass ribbon.

13. The method of claim 9, wherein
the forming of the continuous glass ribbon includes forming the continuous glass ribbon at a first position and at a first temperature;
the inline coating includes inline coating both surfaces of the continuous glass ribbon at a second position that is lower than the first position and at a second temperature that is lower than the first temperature; and
the cutting of the coated glass ribbon includes cutting the coated glass ribbon at a third position that is lower than the second position and at a third temperature that is lower than the second temperature.

14. The method of claim 9, wherein the non-glass material includes one of alumina (Al₂O₃), aluminum oxynitride (AlON), and diamond.

15. The method of claim 9, further comprising applying an annealing process to the coated glass ribbon by an annealing apparatus that is operable to maintain the continuous glass ribbon below 800° C. while heating the non-glass material to a temperature greater than 1000° C.

16. A system for forming a glass sheet comprising an inline coating apparatus that receives a continuous glass ribbon from a glass manufacturing apparatus and coats two surfaces of the continuous glass ribbon with a non-glass material while the continuous glass ribbon is in motion to form a coated glass ribbon.

17. The system of claim 16, wherein the inline coating apparatus includes a first opening and a second opening aligned with each other and configured such that the continuous glass ribbon is able to move through the first opening and second opening during an inline coating process.

18. The system of claim 16 further comprising:
a glass manufacturing apparatus that manufactures the continuous glass ribbon; and
a cutting apparatus configured to receive the coated glass ribbon from the inline coating apparatus and cut the coated glass ribbon into glass sheets.

19. The system of claim 18, further comprising an annealing apparatus that treats the coated non-glass material and is disposed between the inline coating apparatus and the cutting apparatus.

20. The system of claim 16, wherein the inline coating apparatus is configured to perform one of physical vapor deposition (PVD) and chemical vapor deposition (CVD) at atmospheric pressure at a temperature that is higher than room temperature to form the coated glass ribbon such that the coated non-glass material has a compressive stress of at least 700 MPa at room temperature.
